(19) United States
(12) Patent Application Publication
(10) Pub. No.: US 2006/0062964 A1
(43) Pub. Date: Mar. 23, 2006

(54) Hollow assembly structure

(75) Inventors: Tohru Ikuyama, Hyogo (JP); Takashi Shimizu, Hyogo (JP)

Correspondence Address: NIXON PEABODY, LLP, 401 9TH STREET, NW, SUITE 900, WASHINGTON, DC, 20004-2128, US

(73) Assignee: ShinMaywa Industries, Ltd., Takarazuka-shi (JP)

(21) Appl. No.: 10/945,436

(22) Filed: Sep. 21, 2004

(51) Int. Cl. B32B 3/10

(52) U.S. Cl. 428/137

(57) ABSTRACT

The present invention relates to an assembly structure (e.g., a movable trailing edge of an aircraft) in which members are joined to each other without employing riveting. The assembly structure is composed of a box shaped main body and an outer plate. The main body is formed of a shaved member whose bottom, front end portion and rear end portion are formed integrally. Connection portions in thin plate shapes in which a plurality of through holes are formed are provided in the upper side of the main body. The outer plate and the main body are joined to each other by means of studs which are inserted in the through holes of the outer plate and the through holes of the main body, respectively, and are friction-stir-welded with the outer plate and the main body.

### FIELD OF THE INVENTION

The present invention relates to a hollow assembly structure and is applicable to movable trailing edges of aircrafts and doors.

### BACKGROUND OF THE INVENTION

In hollow assembly structures formed by assembling a plurality of members, joining means for joining the members are necessary. As the joining means, adhesives, screws and the like are listed.

However, it is difficult in manufacture of hollow structures with the use of adhesives or screws to ensure light weight and sufficient joint strength. For this reason, when hollow assembly structures are applied to the cases where the joint strength is required to some extent, joining by adhesives or screws is insufficient.

Further, screw joining requires formation of screw holes in members beforehand. However, in the case where the members are thin members, the depth of the screw holes is shallow and it is difficult to form the screw trench of sufficient length in the walls of the screw holes. For this reason, it is difficult to ensure sufficient joint strength, especially in assembling thin members.

In this association, as means for joining thin members to each other firmly, rivets have been used conventionally. Herein, riveting will be described with reference to FIG. 9 and FIG. 10. In the riveting, rivet holes 103, 104 are formed in thin members 101, 102 to be joined to each other (see FIG. 9A or FIG. 10A) beforehand, and a rivet 105 is inserted into the rivet holes 103, 104. After a rivet support anvil 106 is placed at one end side of the rivet 105, the other end of the rivet 105 is struck in the rivet axis direction by a riveter 107 (see FIG. 9B or FIG. 10B). In so doing, the middle part and the end part of the rivet 105 are upset as shown in FIG. 9C or FIG. 10C, whereby the thin member 101 and the thin member 102 are joined to each other by means of the rivet 105.

In the above described riveting, however, it is necessary to place the rivet support anvil at the reverse side of the rivet 105, which is the side opposite the side struck by the riveter 107. Therefore, it is hard to say that workability is sufficiently good.

Moreover, the rivet 105 must be inserted from the outside. However, in particular cases where assembly structures are sealed hollow assembly structures, hands cannot be inserted into the sealed hollow space and the rivet support anvil 106 is difficult to be placed. For this reason, the riveting with no modification is inapplicable to sealed hollowed structures. Further, only blind riveting can be employed. Thus, it is much difficult to ensure sufficient joint strength in sealed hollow structures assembled with thin members.

### SUMMARY OF THE INVENTION

The present invention has been made in view of the above problems and has its object of joining, with high strength, members of a hollow assembly structure not by riveting.

Another object of the present invention is to join members of a hollow assembly structure with increased workability.

An assembly structure according to the present invention is a hollow assembly structure assembled with a first member and a second member as two elements or three or more members including the first member and the second member as elements,

wherein a through hole is formed in the first member,

a concave portion or a through hole of which size corresponds to that of the through hole of the first member is formed in the second member, and

the first member and the second member are joined by means of a column shaped member which is inserted in the through hole of the first member and the concave portion or the through hole of the second member and which is friction-stir-welded with the first member and the second member.

In the above assembly structure, the first member is friction-stir-welded with the column shaped member in the through hole thereof. Also, the second member is friction-stir-welded with the column shaped member in the through hole or the concave portion thereof. Thus, the first member and the second member are joined to each other with sufficient joint strength by means of the column shaped member.

In the friction stir welding of the column shaped member, it is sufficient to insert the column shaped member into the through hole of the first member and the through hole or the concave portion of the second member so as to rub thereagainst, and therefore, it is unnecessary to place a rivet support anvil at the reverse side of the second member as in the riveting. Further, both the members can be joined to each other with sufficient joint strength by operation from one side of the assembly structure (e.g., from outside). Accordingly, the first member and the second member can be joined to each other by simple operation, thereby increasing the workability.

In preferred embodiments of the present invention, the assembly structures are in a cylindrical shape, a box shape and a sealed box shape each of which has a hollow space inside thereof, and the first member and the second member are assembled so that the through hole of the first member is located outside the concave portion or the through hole of the second member.

It should be noted that the aforementioned and below-mentioned term, “sealed structure” includes not only completely sealed structures but also sealed structures of which part is opened.

In assembly structures in cylindrical shapes, box shapes or sealed box shapes, it has been difficult to place a rivet support anvil at the inside thereof, and therefore, the workability in the riveting has been bad or the riveting itself has been difficult to be conducted. However, according to the present invention, no rivet support anvil is necessary to be placed at the inside thereof, and therefore, assembly of structures even in the cylindrical shapes, the box shapes or the sealed box shapes can be facilitated. Further, sufficient joint strength is exhibited compared with the respective cases of joining by means of screws and adhesives.

The first member and the second member may be formed of thin members, respectively.

The column shaped member is friction-stir-welded with the first member and the second member. Thus, both the members are joined to each other with sufficient joint strength even if they are thin members. The first member and the second member, which are formed of thin members, reduce the weight of the assembly structure. Further, cost reduction of the structure is realized with less number of required parts.

It is preferable that either one of the first member and the second member is composed of a shaved member.

In association with recent developments in high-speed shaving technology, members having shapes complicated to some extent can be formed of shaved members. In the present invention, even thin members can be joined to each other with sufficient strength, and therefore, such a shaved member can be employed positively. With the use of such a shaved member, the number of parts of the assembly structure can be reduced, the workability can be increased and the number of assembling steps can be reduced.

It is preferable that the first member, the second member and the column shaped member are made of the same material.

In so doing, electrolytic corrosion is suppressed and resistance to corrosion is increased. The first member, the second member and the column shaped member may be, of course, made of different materials.

The contact faces of the first member and the second member may be adhered with each other by an adhesive.

In so doing, a slit between the first member and the second member is filled with the adhesive, thereby preventing foreign matter such as water from being intruded into the inside of the assembly structure. In addition, the joint strength between the first member and the second member are further increased.

The above assembly structure may compose a whole or a part of a blade.

Wherein, the blade herein includes blades of aircrafts such as fixed wings of aircrafts (main wings, tails and the like), movable trailing edges (flaps, ailerons, elevators and the like) and rotors (blades of helicopters and the like), and further includes a various kinds of blades, such as blades of submarines, vanes of impellers for blowers, vanes of water turbines, vanes of windmills and the like.

Accordingly, a light-weighted blade with high strength can be obtained.

A movable trailing edge of an aircraft according to the present invention is in a hollow assembly structure assembled with the first member and the second member,

wherein the first member is formed in a box shape by a shaving process so as to have an obverse face serving as one of blade faces of the movable trailing edge and a reverse side forming a concave portion, one or two or more ribs being integrally formed at the reverse side and a plate-shaped joint portion in which a plurality of through holes are formed around the concave portion being integrally formed,

the second member is formed in a plate shape so as to have an obverse face serving as the other blade face of the movable trailing edge, through holes corresponding to the through holes of the first member being formed, and

the first member and the second member are joined to each other by means of a column shaped member which is inserted in each through hole of the first member and each through hole of the second member and which is friction-stir-welded with the first member and the second member.

With the above structure, a light-weighted movable trailing edge with high strength can be obtained. In addition, a blade with less number of parts can be obtained through less number of assembling steps.

The first member and the second member may be joined to each other in such a manner that the joint portion of the first member and the reverse face of the second member are adhered to each other by means of an adhesive, in addition to the aforementioned friction-stir-welding.

### BRIEF DESCRIPTION OF DRAWINGS

FIG. 1 is an exploded perspective view of a movable trailing edge according to Embodiment 1 in the present invention.

FIG. 2A and FIG. 2B are explanatory drawings for friction stir welding using a stud.

FIG. 3A and FIG. 3B are partial sections each showing a movable trailing edge according to Modified Example 1 of Embodiment 1.

FIG. 4 is an exploded perspective view showing a blade according to Modified Example 2 of Embodiment 1.

FIG. 5 is a perspective view showing a pole according to Embodiment 2 of the present invention.

FIG. 6 is a perspective view showing a vehicle according to Embodiment 3 of the present invention.

FIG. 7 is a perspective view showing a framework member of a main wing according to Embodiment 4 of the present invention.

FIG. 8 is an exploded perspective view showing a box body according Embodiment 5 of the present invention.

FIG. 9A through FIG. 9C are explanatory drawing of riveting (prior art).

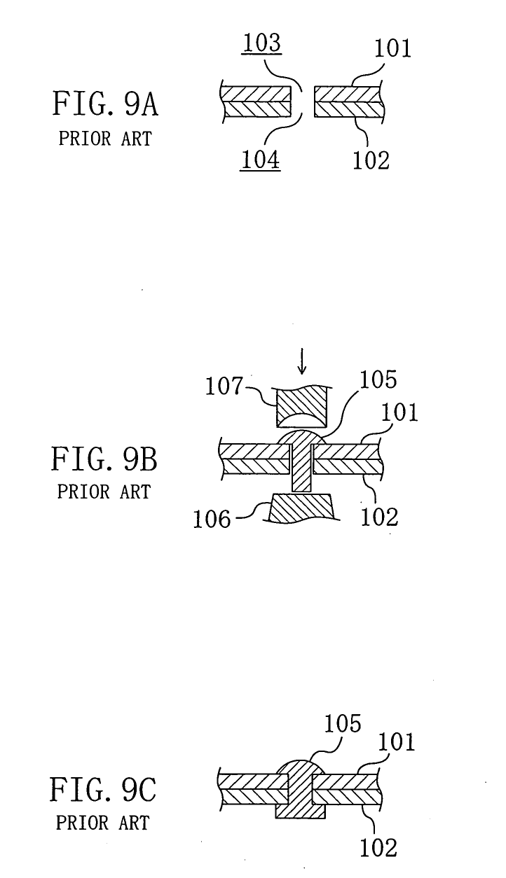

FIG. 10A trough FIG. 10C are explanatory drawing of riveting (prior art).

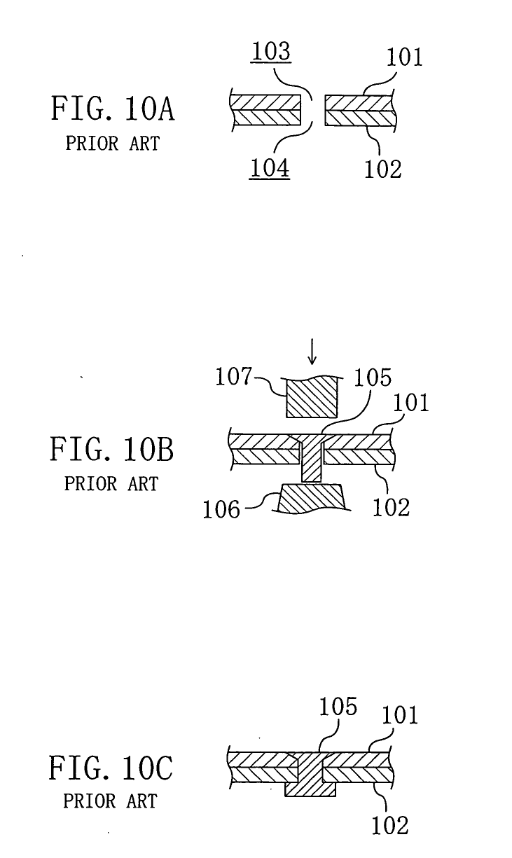

### DETAILED DESCRIPTION OF THE INVENTION

Embodiments of the present invention will be described below with reference to drawings.

### Embodiment 1

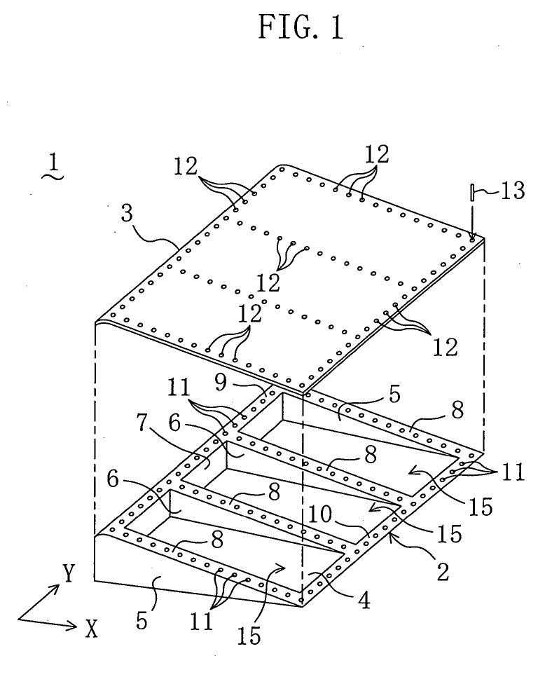

As shown in FIG. 1, an assembly structure according to the present embodiment is a movable trailing edge 1 of an aircraft. The movable trailing edge 1 is formed by assembling a main body 2 serving as a first member and an outer plate 3 serving as a second member.

The main body 2 is formed of a shaved member obtained by shaving a thin plate made of a metal material. The main body 2 is thin in each part, namely, is formed of a thin member. The main body 2 is constituted integrally by: a bottom plate 4 forming one of blade faces; blade end portions 5, 5 protruding upward at respective ends in a span direction (Y direction in the drawing) of the bottom plate 4; ribs 6, 6 protruding upward from the bottom plate 4 between the blade end portions 5, 5; and a front end portion 7 protruding upward from the front end of the bottom plate 4. Wherein, the left side, the right side, the upper side and the lower side in FIG. 1 mean the front side, the rear side, the upper side and lower side, respectively, for the sake of explanation, but these directions do not necessarily correspond to the aspects of the movable trailing edge 1 in use (the same will be applied to the following embodiments.).

The blade end portions 5 and the ribs 6 are formed into long, narrow and thin plates extending back and forth (X direction in the drawing), and have side faces in triangular shapes. The blade end portions 5 and the ribs 6 are arranged in parallel with one another. The inclined faces of the blade end portions 5 and the ribs 6 are formed so as to incline downward from the front side toward the rear side.

In this way, the blade end portions 5, the ribs 6 and the front end portion 7 protrude from the reverse side of the main body 2, so that the main body 2 is in a box shape in which three opening portions 5 are formed by partitioning the main body 2 by the ribs 6 in the present embodiment. It is noted that the obverse face of the main body 2 (lower face in FIG. 1) forms one of the blade faces.

Connection portions 8, 9, 10 are provided in the upper part of the main body 2 (peripheral parts of the openings 15, in detail). Specifically, the joint portions 8 extending transversely from the blade end portions 5 or the ribs 6 so as to form L-shapes are provided in the upper parts of the blade end portions 5 and the ribs 6, respectively. The joint portion 9 extending rearward from the front end portion 7 so as to form an L-shape is provided in the upper part of the front end portion 7. The joint portion 10 is provided at the rear end of the main body 2 so as to extend in the span direction. The joint portion 10 is bent so as to extend from the rear end of the bottom plate 4 frontward. The joint portion 9 of the front end portion 7 is continued with the joint portions 8 of the blade end portions 5 and the ribs 6 smoothly. Also, the joint portion 10 of the rear end is continued with the joint portions 8 of the blade end portions 5 and the ribs 6 smoothly.

Each joint portion 8 through 10 has a long and narrow joint face of a predetermined width and a plurality of through holes 11 passing therethrough are formed therein. The number, intervals and arranged pattern of the through holes 11 are not limited specifically, but the through holes are arranged uniformly at regular intervals in the present embodiment.

On the other hand, the outer plate 3 is a member that forms the other face of the blade and formed of a thin plate made of a metal material. Thus, the outer plate 3 is formed of a thin member, also. The outer plate 3 is formed in a shape to be fitted to the main body 2, and a plurality of through holes 12 respectively corresponding to the through holes 11 of the main body 2 are formed therein. The number, intervals and arranged pattern thereof are the same as those of the through holes 11.

The main body 2 and the outer plate 3 are joined to each other by friction-stir-welding column-shaped studs 13 with the through holes 11, 12, respectively. A method for joining the main body 2 and the outer plate 3 together will be described next.

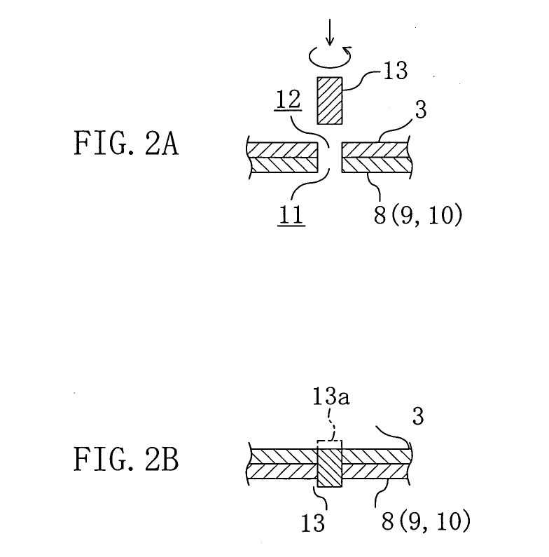

As shown in FIG. 2A, for the joining, the outer plate 3 is laid over the joint portions 8 through 10 of the main body 2 so that the through holes 11 meet the through holes 12, respectively. In other words, the reverse face of the outer plate 3 and the reverse face of the main body 2 are made in contact with each other so as to overlap the through holes 11 with the through holes 12. In this state, the outer plate 3 and the main body 2 form a sealed box-shaped structure having a hollow space inside thereof. Next, the stud 13 is inserted into the through holes 12, 11 from outside while rotating around the axial center of the stud 13. Whereby, the stud 13 is rubbed with the respective wall faces of the through holes 12, 11, is melted at the outer peripheral face thereof by friction heat, and finally, is joined to the wall faces. As a result, the outer plate 3 and the main body 2 are joined to each other by means of the studs 13.

If a part 13a of the stud 13 protrudes from the surface of the outer plate 3 after the outer plate 3 and the main body 2 are joined to each other, as shown in FIG. 2B, the protruding part 13a of the stud 13 is removed so as to level the surfaces of the outer plate 3 and the stud 13.

As described above, the outer plate 3 and the main body 2 are joined to each other firmly by friction sir welding using the studs 13.

It should be noted that the materials of the studs 13, the outer plate 3 and the main body 2 are not limited specifically only if the joint strength between the outer plate 3 and the main body 2 can be ensured. Wherein, in the case where they are made of the same material (for example, in the case where they are all made of aluminum), potential difference between the outer peripheral face of the studs 13 and the respective through holes 11, 12 of the outer plate 3a and the main body 2 becomes low. For this reason, the studs 13, the outer plate 3 and the main body 2 are made of the same material in the present embodiment for increasing resistance to corrosion.

As described above, according to the present embodiment, the studs 13 are inserted, while rotating, into the through holes 12, 11 of the outer plate 3 and the main body 2, so that the studs 13 are friction-stir-welded with the outer plate 3 and the main body 2 to join the outer plate 3 and the main body 2 together firmly. Even though the outer plate 3 and the main body 2 are thin members, the thin members can be firmly fixed to each other. Different from the riveting, it is unnecessary to place a rivet support anvil at the reverse side, which enables easy and speedy assembling of a hollow structure even in a sealed state.

The main body 2 is formed of an integral shaved member. Hence, the joining means is unnecessary, which reduces the weight and cost of the main body 2, compared with a main body composed of a plurality of members.

### Modified Example 1

Condensation may occur on the blade surfaces and the blade surfaces may be exposed to rain. Accordingly, water may enter into the inside of the movable trailing edge 1. Entering of water into the inside of the movable trailing edge shall cause corrosion and the like, which is unfavorable. In this association, it is preferable to intervene a sealing material between the main body 2 and the outer plate 3 so as to prevent water from entering into the inside space of the movable trailing edge 1.

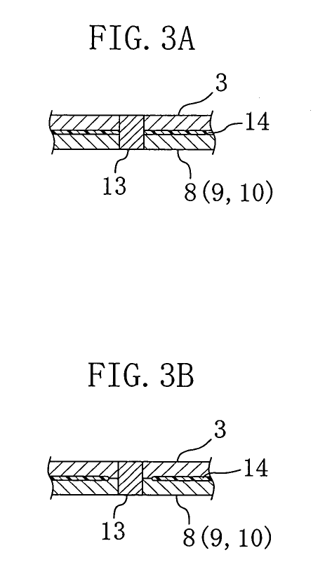

For example, as shown in FIG. 3A and FIG. 3B, an adhesive 14 may be intervened as the sealing material. When the joint faces 8 through 10 of the main body 2 and the outer plate 3 are adhered to each other by means of the adhesive in this way, entering of water into the inside of the movable trailing edge 1 is prevented and the joint strength between the outer plate 3 and the main body 2 is further increased.

### Modified Example 2

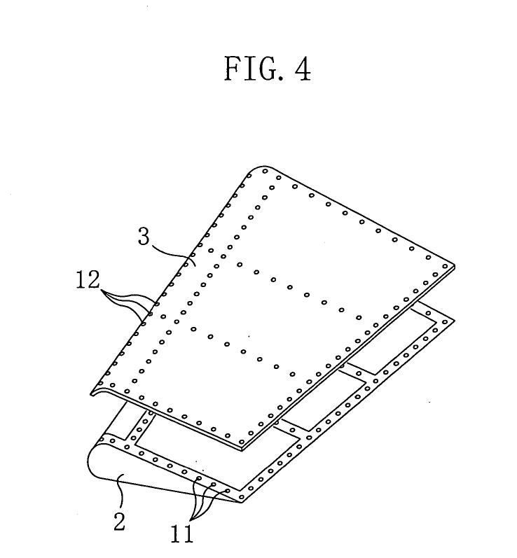

The shape of the movable trailing edge of an aircraft is not limited to that in the above embodiment and the movable trailing edge may be in various shapes. For example, as shown in FIG. 4, the movable trailing edge may be a symmetrical blade of which section is symmetrical between the upper portion and the lower portion, or may be an asymmetric blade. The outer plate 3 is not limited to a flat plate shape and may be curved, of course. Further, the number of the members is not limited to two and may be three or more.

### Embodiment 2

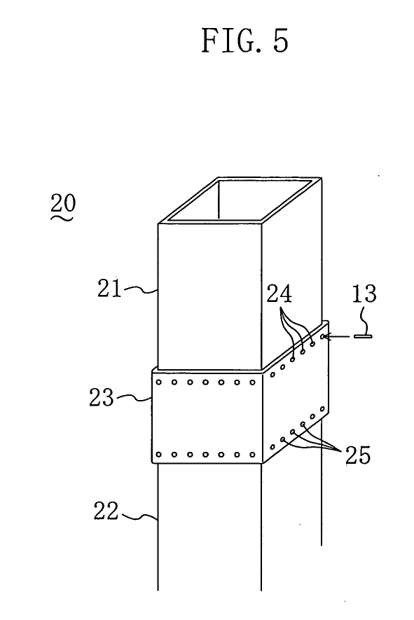

As shown in FIG. 5, an assembly structure according to Embodiment 2 is a pole 20 formed of two or more members. The pole 20 is formed by joining a first pole 21 and a second pole 22 together by means of a coupling 23.

The first pole 21 and the second pole 22 are both rectangular cylindrical members inside which a hollow space is formed. Through holes passing from inside to outside (not shown) are formed at each one end in the axial direction of the first pole 21 and the second pole 22 (specifically, the lower end portion of the first pole 21 and the upper end portion of the second pole 22). The through holes are arranged along the outer peripheries of the respective poles 21, 22 at regular intervals.

The coupling 23 is formed of a rectangular cylindrical member of a size larger than that of the first pole 21 and the second pole 22. Through holes 24 corresponding to the through holes of the first pole 21 are formed in the upper end portion of the coupling 23 and through holes 25 corresponding to the through holes of the second pole 22 are formed in the lower end portion of the coupling 23.

In each inside of the through holes 24 in the upper end portion of the coupling 23 and the through holes of the first pole 21, the stud 13 is friction-stir-welded. As well, the stud 13 is friction-stir-welded in each inside of the through holes 25 in the lower end portion of the coupling 23 and the through holes of the second pole 22. The friction stir welding of the studs 13 is the same as that in Embodiment 1 and the description thereof is omitted here.

In the present embodiment, similar to Embodiment 1, the thin members can be joined to each other firmly. In addition, easy and speedy assembling of even a hollow structure is enabled.

### Embodiment 3

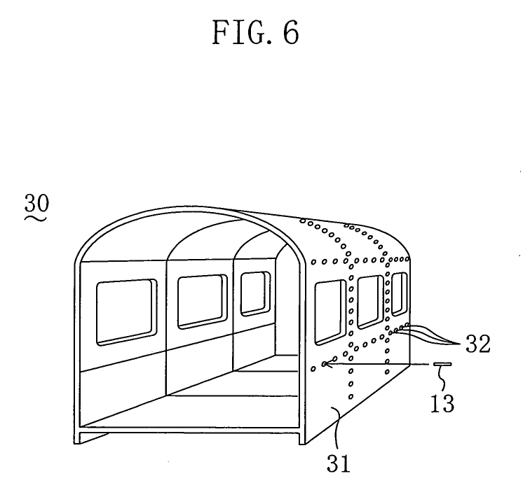

As shown in FIG. 6, an assembly structure in the present embodiment is a vehicle 30 of a train. The vehicle 30 is formed by joining a plurality of outer plates 31 to a skeleton member (not shown). A plurality of through holes 32 are formed in the skeleton member and the outer plates 31, respectively. In each inside of the through holes 32 of the outer plate 31 and the through holes of the skeleton member, the stud 13 is friction-stir-welded, similar to the above described embodiments. Thus, in the present embodiment, the vehicle 30 having high joint strength can be assembled easily and speedily.

### Embodiment 4

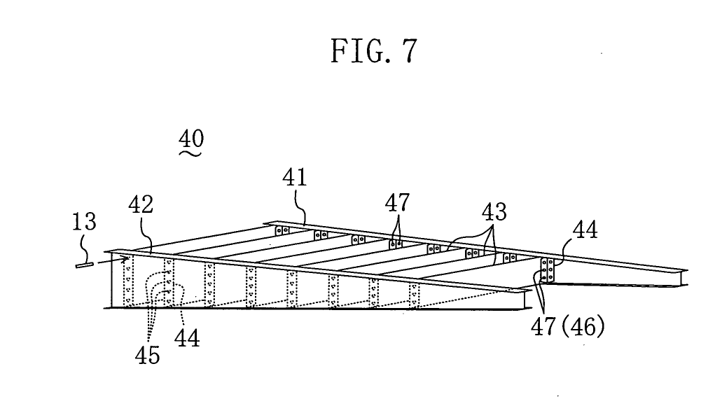

As shown in FIG. 7, an assembly structure according to Embodiment 4 is a framework member 40 of a main blade for an aircraft. The framework member 40 is formed by assembling a front spar 41, a rear spar 42 and a plurality of ribs 43. Each rib 43 is joined at the front and rear ends thereof to the front spar 41 and the rear spar 42 by means of angular couplings 44 of L-shapes in section.

A plurality of through holes 46 are formed in the front spar 41 and the rear spar 42 in the vertical direction in FIG. 7 so as to be arranged at a regular intervals in the span direction (transverse direction in FIG. 7). Also, a plurality of through holes 46 are formed in both end portions of each rib 43 in the vertical direction. Through holes 47 respectively corresponding to the through holes 45 or 46 are formed in each angular coupling 44.

Similar to Embodiments 1 and 2, the stud 13 is friction-stir-welded in the inner faces of each through hole 47 of the angular couplings 44 and each through holes 45, 46. Whereby, the front spar 41, the rear spar 42 and the ribs 43 are joined firmly to the angular couplings 44. Thus, the front spar 41, the ribs 43 and the rear spar 42 are assembled with one anther firmly by means of the angular couplings 44.

As described above, similar to the above described embodiments, thin members are joined to each other easily, speedily and firmly in the present embodiment.

An outer plate or the like forming a blade face would be assembled to the framework member 40 after the framework member 40 is assembled as above. However, such an outer plate or the like and the framework member 40 may be, of course, joined in the same manner as above. Namely, the outer plate or the like and the framework member 40 may be joined utilizing the friction stir welding with the use of studs.

### Embodiment 5

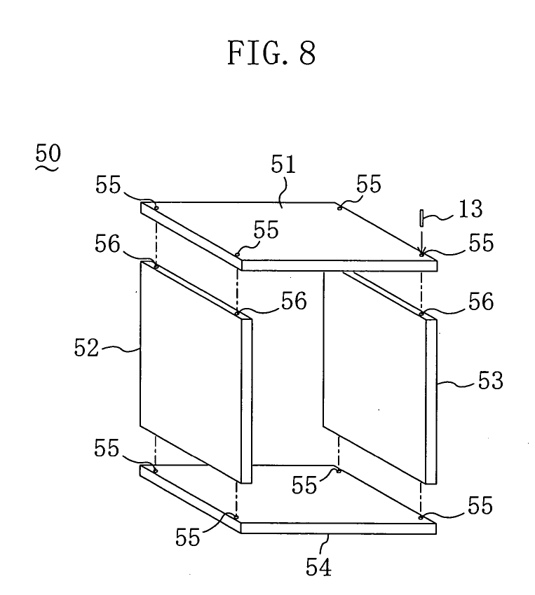

As shown in FIG. 8, an assembly structure according to Embodiment 5 is a box body 50 formed by assembling a plurality of members. The box body 50 is formed by assembling a top plate 51, side plates 52, 53 and a bottom plate 54.

A through hole 55 is formed at each of the respective four corner portions of the top plate 51 and the bottom plate 54. On the other hand, a concave portion 56 corresponding to the through hole 55 of the top plate 51 or the bottom plate 54 is formed in each of the respective upper faces and lower faces of the side plates 52, 53. In other words, in the side plates 52, 53, the concave portions 56 of which size corresponds to that of the through holes 55 are formed at positions corresponding to the through holes 55 of the top plate 51 and the bottom plate 54, respectively.

Similar to the above described embodiments, the stud 13 is friction-stir-welded in each inside of the through holes 55 of the top plate 51 and the concave portions 56 in the respective upper face portions of the side plates 52, 53. Also, the stud 13 is friction-stir-welded in each inside of the through holes 55 of the bottom plate 54 and the concave portion 56 in the respective lower face portions of the side plates 52, 53. Wherein, the stud 13 is inserted from the outside. In detail, the top plate 51 and the side plates 52, 53 are joined to each other by inserting the studs 13 from the upper side, and the bottom plate 54 and the side plates 52, 53 are joined to each other by inserting the stud 13 from the lower side.

Hence, in the present embodiment, also, a plurality of members can be joined firmly, and the box body 50 can be assembled easily and speedily.

It should be noted that it is possible that a front plate and a rear plate (not shown) are joined to the box body 50 in the same manner as that for the side plates 52, 53 to form the box body 50 as a hollow structure in a completely sealed state.

If a through hole is formed in one member and a concave portion corresponding to the through hole is formed in another member as in the present embodiment, the other member is not limited to a thin member. Thus, joining between a thin member and a thick member is enabled.

### Other Embodiments

The present invention is not limited to the above embodiments and is applicable to various kinds of modes. For example, the present invention is applicable to other assembly structures used in the case where it is exposed to fluid, such as doors of aircrafts, blades of helicopters, vanes of windmills, marine screws, impellers of blowers, vanes of water turbines and the like. In addition, the present invention is applicable to assembly structures such as racks, metal furniture and the like.

What is claimed is:

1. A hollow assembly structure comprising:
a first member; and a second member as two elements or three or more members including the first member and the second member as elements, which are assembled,
wherein a through hole is formed in the first member,
a concave portion or a through hole of which size corresponds to that of the through hole of the first member is formed in the second member, and
the first member and the second member are joined by means a column shaped member which is inserted in the through hole of the first member and the concave portion or the through hole of the second member and which is friction-stir-welded with the first member and the second member.

2. The hollow assembly structure of claim 1, wherein
the first member and the second member are formed of thin members, respectively.

3. The hollow assembly structure of claim 1 or 2, wherein
either one or each of the first member and the second member is formed of a shaved member.

4. The hollow assembly structure of claim 1 or 2, wherein
the first member, the second member and the column shaped member are made of the same material.

5. The hollow assembly structure of claim 1 or 2, wherein
the first member and the second member are adhered at respective contact faces to each other by means of an adhesive.

6. The hollow assembly structure of claim 1 or 2, which composes a part or whole of a blade.

7. The hollow assembly structure of claim 6, which is a movable trailing edge of an aircraft which is assembled with the first member and the second member,
the first member is formed in a boxed shape by a shaving process so as to have an obverse face serving as one of blade faces of the movable trailing edge and a reverse side forming a concave portion, one or two or more ribs being integrally formed at the reverse side, and a plate-shaped joint portion in which a plurality of through holes are formed around the concave portion being integrally formed,
the second member is formed in a plate shape so as to have an obverse face serving as another blade face of the movable trailing edge, through holes corresponding to the through holes of the first member being formed, and
the first member and the second member are joined to each other by means of a column shaped member which is inserted in each through hole of the first member and each through hole of the second member and which is friction-stir-welded with the first member and the second member.
